(19) United States
(12) Patent Application Publication
(10) Pub. No.: US 2009/0066641 A1
(43) Pub. Date: Mar. 12, 2009

(54) Methods and Systems for Interpretation and Processing of Data Streams

(75) Inventors: Satyender Mahajan, Cambridge, MA (US); Zachery LaValley, Leominster, MA (US); Nabori Santiago, Springfield, MA (US); Arun Mehta, Cambridge, MA (US); Satayan Mahajan, Cambridge, MA (US)

Correspondence Address: CHOATE, HALL & STEWART LLP, TWO INTERNATIONAL PLACE, BOSTON, MA, 02110, US

(73) Assignee: Motus Corporation, Cambridge, MA (US)

(21) Appl. No.: 12/268,677

(22) Filed: Nov. 11, 2008

Related U.S. Application Data
(63) Continuation-in-part of application No. 11/367,629, filed on Mar. 3, 2006.
(60) Provisional application No. 60/660,261, filed on Mar. 10, 2005.
(60) Provisional application No. 61/058,387, filed on Jun. 3, 2008.

(51) Int. Cl. G06T 15/70

(52) U.S. Cl. 345/156

(57) ABSTRACT

Methods and systems for interpreting and processing data streams from a plurality of sensors on a motion-capture device are described. In various embodiments, an engine module of the system receives a raw input data stream comprising motion and non-motion data. Metadata is associated with data segments within the input data stream to produce a stream of data profiles. In various embodiments, an interpreter converts received data profiles into non-contextual tokens and/or commands recognizable by an application adapted for external control. In various embodiments, a parser converts received non-contextual tokens into contextual tokens and/or commands recognizable by an application adapted for external control. In various embodiments, the system produces commands based upon the non-contextual and/or contextual tokens and provides the commands to the application. The application can be a video game, software operating on a computer, or a remote-controlled apparatus. In various aspects, the methods and systems transform motions and operation of a motion-capture device into useful commands which control an application adapted for external control.

### RELATED APPLICATIONS

The present application is a continuation-in-part application of U.S. non-provisional patent application Ser. No. 11/367,629 filed Mar. 3, 2006, which claims priority to U.S. provisional patent application No. 60/660,261 filed Mar. 10, 2005. The present application also claims priority to U.S. provisional patent application 61/058,387 filed Jun. 3, 2008.

### FIELD OF THE INVENTION

The present invention is directed to the field of analyzing motion and more specifically to an apparatus, system and method for interpreting and reproducing physical motion. The embodiments described herein also relate to language-based interpretation and processing of data derived from multiple motion and non-motion sensors. More particularly, the embodiments relate to interpreting characteristics and patterns within received data sets or data streams and utilizing the interpreted characteristics and patterns to provide commands to control a system or apparatus adapted for remote control.

### BACKGROUND

Motion sensing devices and systems, including utilization in virtual reality devices, are known in the art, see U.S. Pat. App. Pub. No. 2003/0024311 to Perkins, U.S. Pat. App. Pub. No. 2002/0123386 to Perlmutter, U.S. Pat. No. 5,819,206 to Horton, et al; U.S. Pat. No. 5,898,421 to Quinn; U.S. Pat. No. 5,694,340 to Kim; and U.S. Pat. No. RE37,374 to Roston, et al., which are all incorporated herein by reference.

Accordingly, there is a need for an apparatus, system and method that can facilitate the interpretation and reproduction of sensed physical motion.

Sensors can provide information descriptive of an environment, a subject, or a device. The information can be processed electronically to gain an understanding of the environment, subject, or device. As an example, something as ubiquitous as a computer mouse can utilize light-emitting diodes or laser diodes and photodetectors to sense movement of the mouse by a user. Information from the sensor may be combined with input specified by the user, e.g., movement sensitivity or mouse speed, to move a cursor on the computer screen. In more advanced applications, complex sensors and/or multiple sets of sensors are utilized to determine motion in three-dimensional (3D) space, or to recognize and analyze key information about a device or its environment. Examples of more advanced sensor applications are provided in applicant's co-pending U.S. patent application Ser. No. 10/742,264; Ser. No. 11/133,048; Ser. No. 11/367,629, and Ser. No. 61/020,574, each of which is incorporated by reference. In the field of robotics, both primitive and highly advanced sets of sensors may be used to provide information or feedback to a robot's central processor about anything from the 3D motion of an appendage, or the internal temperature of servos, to the amount of gamma radiation impinging on the robot. Efficient processing of information provided from multiple sensors can allow a robot to be more “human-like” in their interaction and understanding of their environment and entities within the environment. As the number, variety, and complexity of sensors increase or scale upwards, the interpretation and processing of sensor data becomes more difficult to implement using conventional algorithms or heuristics.

### SUMMARY

An apparatus, system and method for turning physical motion into an interpretable language which when formed into sentences represents the original motion. This system may be referred to herein as a “Motion Description System.” Physical motion is defined as motion in one, two or three dimensions, with anywhere from 1 to 6 degrees of freedom. Language is defined as meaning applied to an abstraction.

In various embodiments, methods and systems are described which provide language-based interpretation and processing of data derived from multiple sensors, and provide output data for controlling an application adapted for external control. The application adapted for external control can comprise an electronic device, a computer system, a video gaming system, a remotely-operated vehicle, a robot or robotic instrument.

In various embodiments, a method for interpreting and processing data derived from multiple sensors is described. In certain embodiments, the method comprises the step of receiving, by a data profile processor, input data where the input data comprises motion data and non-motion data. The motion data can be provided by one or more motion-capture devices and be representative of aspects of motion of the one or more motion-capture devices. The method can further comprise generating, by the data profile processor, a stream of data profiles where a data profile comprises metadata associated with a segment of the received input data. The method can further comprise processing, by an interpreter, the data profiles to generate non-contextual tokens wherein the non-contextual tokens are representative of the motion data and non-motion data. In various embodiments, commands which are recognizable by an application adapted for external control can be associated, by the interpreter, with the non-contextual tokens, and the interpreter can provide the commands to the application.

In various embodiments, a system for interpreting and processing data derived from multiple sensors is described. In certain embodiments, the system comprises a data profile processor adapted to receive input data where the input data comprises motion and non-motion data. The motion data can be provided by one or more motion-capture devices and representative of aspects of motion of the one or more motion-capture devices. In various aspects, the data profile processor is adapted to generate a stream of data profiles where a data profile comprises metadata associated with a segment of the received input data. The system further comprises an interpreter adapted to receive a stream of data profiles and to generate non-contextual tokens from the stream of data profiles, wherein the non-contextual tokens are representative of the motion and non-motion data. In various aspects, the interpreter is further adapted to associate commands, recognizable by an application adapted for external control, with the non-contextual tokens and provide the commands to the application.

In certain embodiments, the system comprises an engine module, wherein the engine module is adapted to receive input data. The input data comprises motion data and non-motion data, and the motion data can be provided by one or more motion-capture devices and representative of aspects of motion of the one or more motion-capture devices. In various embodiments, the engine module is further adapted to process the motion and non-motion data to produce contextual and/or non-contextual tokens. The engine module can be further adapted to associate commands with the contextual and/or non-contextual tokens, wherein the commands are recognizable by an application adapted for external control. In various aspects, the engine module is in communication with the application and is further adapted to provide the commands to the application. Further, the engine module comprises a sensor profile unit, wherein the sensor profile unit is configurable at development time and is reconfigurable at run time.

The foregoing and other aspects, embodiments, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1A is a schematic illustration of a system 5 used to turn physical motion into an interpretable language, according to various embodiments of the invention.

FIG. 1B represents a block diagram of an embodiment of a system for language-based interpretation and processing of data derived from multiple sensors.

FIG. 2 depicts an example of a sensor input profile data structure.

FIGS. 3A-3G depict various types of motions.

The features and advantages of the present invention will become more apparent from the detailed description set forth below when taken in conjunction with the drawings.

### DETAILED DESCRIPTION

### I. Introduction

Conventional methods for interpreting and processing sensor information derived from various types of sensor devices utilize direct data evaluation and algorithms that are tailored to a particular system and/or application. These data interpretation and processing methods can become computationally intensive and cumbersome when the amount, complexity and variety of sensor devices and corresponding sensor information increases. Conventional systems and methods lack extensible or adaptive capabilities to handle complex multi-sensor input.

In various aspects, methods and systems are described herein that improve upon interpretation and processing of data streams received from a plurality of motion and non-motion sensor devices. In various embodiments, methods and systems described herein are extensible and adaptive, and apply language-based processing techniques in conjunction with artificial intelligence and statistical methods to data inputs comprised of motion sensor data, non-motion sensor data, and/or other system inputs. The methods and systems are useful for efficiently interpreting and processing data from a plurality of input devices, and providing useful commands to control an application adapted for external control.

### II. System Embodiments

In various embodiments, a system for interpreting and processing data from a plurality of input devices comprises a motion interpretation unit or an engine module. In some embodiments, a system for interpreting and processing data from a plurality of input devices comprises a motion interpretation unit or engine module and a motion sensing unit or a device module. In some embodiments, a system for interpreting and processing data from a plurality of input devices comprises a motion interpretation unit, a motion sensing unit, a command generator, wherein one or more components of the motion interpretation unit are user editable. In some embodiments, a system for interpreting and processing data from a plurality of input devices comprises an engine module, a device module, and a creation module. Various aspects of the embodiments are described below.

### II-A. Embodiment A

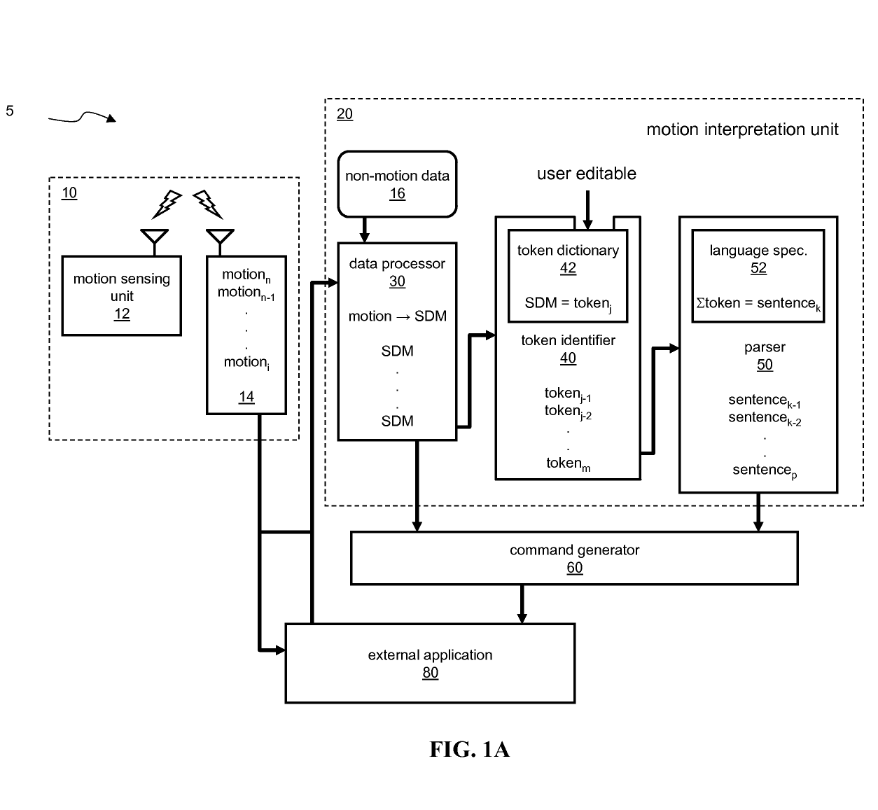

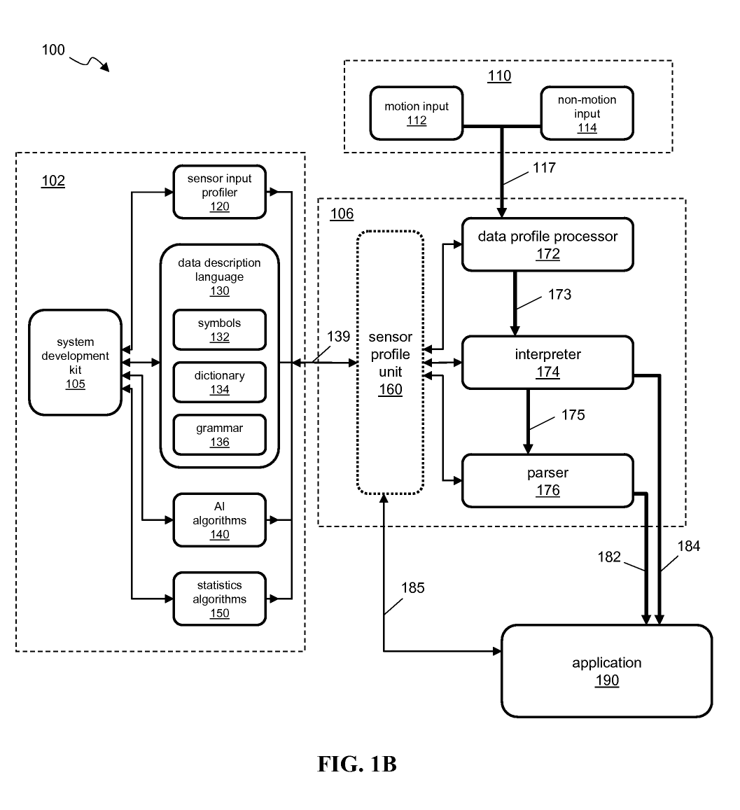

FIG. 1A is a schematic illustration of a system 5 used to turn physical motion into an interpretable language, according to various embodiments of the present invention. When formed into sentences the interpretable language may be used to abstractly replace the original physical motion. Embodiments of system components are described below.

### II-A-1. Motion Sensing

In one embodiment, a motion sensing module 10 is described as follows. Physical motion is captured using a motion capture device 12 such as, but not limited to, one or more of the following: accelerometer, gyroscope, RF tag, magnetic sensor, compass, global positioning unit, fiber-optic interferometers, piezo sensors, strain gauges, cameras, etc. Data is received from the motion capture device 12 and transferred to the motion interpretation module 20, for example via a data reception and transmission device 14. As shown by the multiple embodiments illustrated, the motion data may then be transferred directly to the motion interpretation module 20 or may be transferred via an external application 80, such as a program that utilizes the raw motion data as well as the commands received from the motion interpretation module 20 (described below). Data transfer may be accomplished by direct electrical connection, by wireless data transmission or by other data transfer mechanisms as known to those skilled in the art of electronic data transmission.

### II-A-2. Motion Interpretation

In one embodiment, a motion interpretation module 20 contains the following components:

II-A-2-a. Data Processor 30

Raw motions are periodically sampled from the one or more physical motion capture devices 12 of the motion sensing module 10.

Raw non-motion data is periodically sampled and input from a non-motion data device 112 (i.e. keyboard, voice, mouse, etc.).

A single sample of Complex Motion data is preliminarily processed. The Complex Motion data is defined as the combined sample of all raw physical motion captured by the motion capture device(s) and all non-motion data as defined above.

All the Single Degree Motion (SDM) components are identified from the Complex Motion data. The Single Degree Motion components are defined as the expression of a multi-dimensional motion in terms of single dimension vectors in a given reference frame.

II-A-2-b. Token Identifier (TI) or Tokenizer 40

The tokenizer 40 receives as input a stream of Single Degree Motion component samples.

Every time subsequent subset of samples is marked as a possible token.

A token dictionary 42 exists. The token dictionary is defined as a list of simple meanings given to SDM components. The token dictionary is editable.

Sample groups marked for tokenization are compared against the token dictionary 42 and are either discarded (as bad syntax) or given token status.

II-A-2-c. Parser 50

The parser 50 receives as input a stream of tokenized 3D Complex Motion/Non-Motion data.

Using a language specification 52, the tokens are grouped into sentences. In one embodiment, the system contains a default language specification.

II-A-2-d. Command Generator 60

The command generator 60 receives as input a sentence and outputs commands based on sentences and non-motion related inputs.

At any time a user may create or teach the system new language (i.e. tokens, sentences) by associating a raw motion with an output command. Output commands can include, but are not limited to, application context specific actions, keystrokes, mouse movements. In one embodiment, the output command is sent to the external application 80.

Languages may be context driven and created for any specific application.

In the one embodiment, for example golf, motions of the club may be interpreted too mean “good swing,” “fade to the right,” etc.

### II-B. Embodiment B

Referring now to FIG. 1B, an embodiment of a system 100 for interpretation and processing of data derived from multiple sensors and/or input devices is depicted in block diagram form. The figure also embodies an overall architecture for the system 100. In overview, the system comprises a device module 110, a creation module 102, and an engine module 106. In various embodiments, the engine module 106 may be configured for operation by input 139 received from the creation module 102. The engine module 106 may further receive motion and/or non-motion data from a plurality of sensors and input devices within the device module 110, and output commands 182 and/or 184 to an application 190 adapted for external control. In certain embodiments, the system 100 comprises at least the creation module 102 and engine module 106, and optionally the device module 110.

In certain embodiments and in overview, the system 100 further comprises the following components: motion input 112, non-motion input 114, a system development kit 105, sensor input profiler 120, data description language 130, artificial intelligence algorithms 140, statistics algorithms 150, optionally a sensor profile 160, a data profile processor 172, an interpreter 174, and a parser 176. In certain embodiments, each component of the system 100 is customizable to allow for its adaptation to control any number or type of applications. In some embodiments, functional aspects of the sensor input profiler 120, data description language 130, sensor profile unit 160, data profile processor 172, interpreter 174, and parser 176 may each be altered or configured separately by a system developer. In some embodiments, alterations of these system components are made through the system development kit 105 during a process of configuring the system for operation, e.g., during development time. In some embodiments, alterations of system components are made on-the-fly by the engine module 106 during system operation, e.g., during run time. The alterations of certain system components may be determined from results achieved in the controlled application 190, wherein information representative of the results can be fed back through communication link 185 to the sensor profile unit 160.

In various embodiments, the system 100 is an extensible and adaptable system that utilizes metadata associations to create pieces of information, termed data profiles, descriptive of sensor and/or device output and descriptive of the data itself. These pieces of information can be utilized for subsequent pattern recognition, analysis, interpretation, and processing to efficiently generate commands based on the input data 117. In certain aspects, the analysis of the data profiles utilizes language-based techniques to impart non-contextual and/or contextual meaning to the data profiles. In certain embodiments, configurations developed with the system 100 are re-usable and expandable, allowing for scalability without loss of prior work. As an example, configurations may be developed for one particular application that work with smaller sets of input data, and these configurations may be expanded or used in multiples in conjunction with each other to build a final configuration for the engine module 106. In some embodiments, multiple systems 100 may be used together, in parallel or serially, for more complex data processing tasks. Further aspects of the system 100 are provided in the following sections and in reference to FIG. 1B.

### II-B-1. Device Module 110

In various embodiments, the device module 110 comprises one or more non-motion devices and/or one or more motion devices. The motion devices can provide motion input 112 and the non-motion devices can provide non-motion input 114 to the engine module 106. The motion or non-motion data can be derived from one or more sensors. The data can also be derived from one or more non-sensor devices, e.g., user input devices such as keyboards, microphones with voice recognition software, datapad entry, etc.

In various aspects, motion input 112 comprises data that is representative of aspects of the motion of an object or a related environment, e.g., speed, translation, orientation, position, etc. The motion input 112 is provided as input to the engine module 106. In various aspects, non-motion input 114 comprises data that is representative of a non-motion based state, aspect, or condition, of an object or a related environment, e.g., temperature, keystroke, button press, strain gauge, etc. The non-motion input 114 is provided as input to the engine module 106. In some embodiments, the motion data or non-motion data can be partially processed, e.g., compressed, formatted, culled, or the like, before it is provided to the engine module 106.

When motion or non-motion data is generated by a particular motion or non-motion device, the generated data may also include a header or configuration ID providing information that indicates the data has been generated by the particular motion or non-motion device. For example, a particular accelerometer can include a particular configuration ID with data produced by the accelerometer. In certain embodiments, the particular device generating the data attaches the configuration ID to the data segment. The configuration ID can be included at the front of a data segment, wherein the data segment comprises the configuration ID followed by the data representative of motion or non-motion.

The motion input 112 and non-motion input 114 can be combined into one raw data stream 117 and provided to the engine module 106. In some embodiments, the motion input 112 and non-motion input 114 are provided in a serial data stream. The motion data and non-motion data can be interleaved as it is provided to the engine module 106. In some embodiments, the motion input 112 and non-motion input 114 are provided in a parallel data stream. In some embodiments, the motion data and non-motion data can be provided substantially simultaneously in separate parallel or serial data streams. In various embodiments, the raw data stream 117 will be unformatted and there will be no metadata associated with the motion and non-motion data segments within the raw data stream 117.

In various embodiments, inputs 112, 114 can include, but are not limited to, low-level motion-sensor outputs, processed motion data, low-level non-motion sensor outputs, and processed non-motion data. In certain embodiments, input data 117 can include feedback from one or more system 100 outputs from a current instantiation of the system 100, e.g., to provide historical data, and/or one or more outputs from other instantiations of the system 100. In various aspects, raw data input 117 can take the form of, but not be limited to, digital signals, analog signals, wireless signals, optical signals, audio signals, video signals, control signals, MIDI, bioelectric signals, RFID signals, GPS, ultrasonic signals, RSSI and any other data stream or data set that might require real-time or post-processing analysis and recognition. Examples of hardware which can provide input signals include, but are not limited to, accelerometers, gyroscopes, magnetometers, buttons, keyboards, mice, game controllers, remote controls, dials, switches, piezo-electric sensors, pressure sensors, humidity sensors, optical sensors, interferometers, strain gauges, microphones, temperature sensors, heart-rate sensors, blood pressure sensors, RFID transponders and any combination thereof. These lists are not exhaustive and any other devices or signals providing information about an environment or entity can be utilized to provide input data to the system's engine module 106.

As described above, the raw data input 117 can be received by the engine module 106 in a variety of forms and by itself comprise somewhat abstract data. The data can be received from a variety of sensor types substantially simultaneously. The usefulness of input data is, in certain aspects, linked to the ability of the engine module 106 to recognize the received input data. The engine module's ability to recognize received input data is based upon a current configuration of certain components within the system 100. In particular, the configuration of the sensor profile unit 160 and/or the sensor input profiler 120 and data description language 130 will determine the engine module's ability to recognize received input data and extract meaning from the received data. These and related aspects of the invention are described in the following sections.

### II-B-2. Creation Module 102

In various embodiments, the creation module 102 comprises configurable components providing information and algorithms to the engine module 106 which utilizes them in establishing meaning for data segments received in the raw data input 117. In certain embodiments, the creation module 102 comprises a system development kit (SDK) 105, a sensor input profiler 120, a data description language 130, and optionally AI algorithms 140 and statistics algorithms 150. In some embodiments, the creation module 102 can be implemented as software or firmware executing on a processor in conjunction with memory in communication with the processor. In some embodiments, the creation module 102 can be implemented as a combination of hardware in addition to software or firmware executing on a processor in conjunction with memory in communication with the processor. In various embodiments, certain components within the creation module 102, e.g., sensor input profiler 120, data description language 130, AI algorithms 140, and/or statistical algorithms 150, are editable and configurable by a user or developer. These components can be created and/or modified using the system development kit (SDK) 105. The SDK 105 provides tools to develop, define and test components within the creation module 102.

II-B-2-a. Sensor Input Profiler 120

The sensor input profiler 120 stores sensor input profiles comprising metadata that is descriptive of input data 117. Each sensor input profile can be a block of data that contains information which is descriptive of the properties of a certain sensor or input device or its data. In various embodiments, a sensor input profile comprises configurable metadata that defines an input data block and qualifies the information provided by a particular sensor or non-sensor input device. In various aspects, a wide variety of input data devices are adaptable for use with the system 100 by providing or defining appropriate metadata to be associated with any particular input device data, wherein the metadata is defined and stored within the sensor input profiler 120.

In various aspects, a raw data segment from a sensor or non-sensor input device generally is representative of a measured or generated value and has a configuration ID associated with it. However, the data segment includes no information about the type of data or constraints on the data. The sensor input profiler 120 can catalog information about the data, e.g., comprise a database of metadata, associated with various sensor and non-sensor devices. This catalog or database provides a resource for the system 100 to aid in the system's ability to understand what “type” of information it is working with when input data 117 is received. In certain embodiments, a hardware specification sheet provided with a particular sensor or non-sensor device can provide sufficient details that can be translated or cast into an appropriate sensor input profile. As an example, information that a sensor input profile can contain includes, but is not limited to, ranges of possible output values from a sensor, any errors associated with the output, “type” of information contained, e.g., “thermal” for a temperature sensor, “binary” for a switch, button or other two-state sensor, “acceleration” for a accelerometer, etc., sample rate of the sensor, and the like.

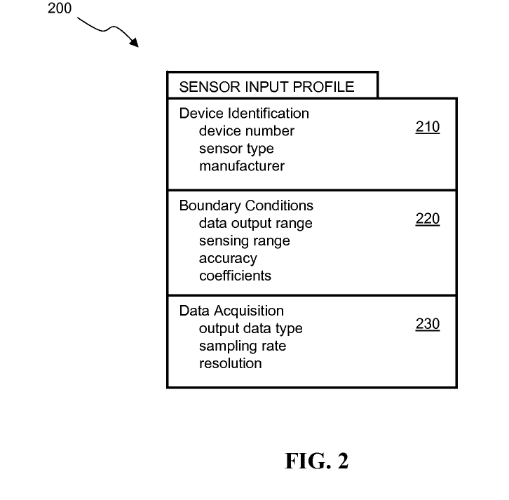

An embodiment of a sensor input profile 200 is depicted in FIG. 2. In various embodiments, a sensor input profile comprises information about the device which generated the data segment and/or information about the data. In certain embodiments, a sensor input profile 200 comprises plural data blocks 210, 220, 230. A device identification data block 210 may include information about a particular hardware sensor or non-sensor device, e.g., the device name, type of sensor, and manufacturer identification. A boundary conditions data block 220 may include information about limitations of the particular device, e.g., maximum output range, maximum sensing range, accuracy of the device over the sensing range, and any correction or gain coefficients associated with sensing measurements. A data acquisition data block 230 may include information about output data type, e.g., digital or analog, data sampling rate, and data resolution, e.g., 1 bit, 8 bit, 12 bit, 16 bit, etc.

As an example, the particular sensor input profile depicted in FIG. 2 may be used for a temperature sensor model LM94022 available from National Semiconductor. A section of computer code representative of a sensor input profile 200 for a temperature sensor can comprise the following instructions:

<SensorInputProfile>

<name>LM94022</name>
<types>Temperature, Thermal</types>
<company>National Semiconductor</company>
<voltage>
<range>1.5 , 5.5</range>
</voltage>
<output>
<range>−50 , 150</range>

<units>celcius, degC</units>

</output>
<accuracy>
<range>20 , 40</range>, <error>1.5</error>,
<range>−50, 70</range>, <error>1.8</error>
<range>−50, 90</range>, <error>2.1</error>
<range>−50, 150</range>, <error> 2.7 </error>
</accuracy>
<gain>

<range> −5.5, −13.6 </range>

<unit> mV/degC </unit>
</gain>
</sample>
<types>Digital, Discrete</types>
<rate> 10 </rate>
<resolution> 12 </resolution>
</sample>

</SensorInputProfile>

It will be appreciated that embodiments utilizing sensor input profiles 200 which incorporate metadata can be extended to other sensor and non-sensor input device types, which can be either more complex or more primitive. Sensor input profiles for inputs from various hardware devices can be formulated by utilizing information from a specification sheet or understanding gathered from operation of the device. As an example, the inventors utilize a variety of motion sensors that are located on and detect aspects of motion, e.g., current position, current orientation, rotational velocity, rotational acceleration, velocity, acceleration, and any combination thereof, of one or more motion-capture devices in combination with non-motion input devices located on the motion-capture devices. The inventors have developed sensor input profiles for the plurality of sensor and non-motion devices used. The sensor input profiles provide descriptive information about data from each sensor and non-motion device which provides raw data to the system's engine module 106.

By defining and providing metadata descriptive of the raw data that a sensor or non-sensor device can provide, the system 100 can expand the content of raw input data and increase the functionality and usefulness of that data within the system. In various aspects, sensor input profiles 200 are utilized by the data profile processor 172 while processing incoming raw data 117 to form data profiles and output a stream of data profiles 173.

II-B-2-b. Data Description Language 130

The data description language 130 is an editable component of the creation module 102 comprising language-type building blocks used by the system 100 during language-based processing of data profiles 173 generated by the data profile processor 172. Similar to defining the components and constructs of a language, a data description language 130 consists of a set of symbols 132, a dictionary 134, and grammar 136. The data description language 130 can comprise a symbols element 132 comprising a collection of fundamental data-blocks or symbols, a dictionary element 134 comprising a collection of tokens, where tokens are valid combinations of symbols, and a grammar element 136 comprising rules dictating a valid combination of tokens. In some embodiments, the data description language 130 comprises plural symbols elements, plural dictionary elements and/or plural grammar elements where each element comprises a set of symbols, tokens, or grammar rules. In various aspects, the data description language 130 is utilized and/or accessed by the engine module 106 during processing and analysis of received raw input data 117.

The system 100 utilizes information from the data description language 130 to provide meaning to the received raw input data 117. In various embodiments, the engine module 106 looks to information defined within the data description language 130 when determining or extracting meaning from received raw input data 117. In certain embodiments, the data description language 130, sensor input profiler 120, sensor profile unit 160, and data profile processor 172 share components of information that provide meaning to the raw input data.

In various embodiments, the symbols element 132 comprises plural symbols. The symbols element 132 can be a list of entries in memory with each entry corresponding to a unique symbol. Each symbol has a corresponding valid data profile, portion of a valid data profile, or collection of data profiles. The symbols element 132 can be utilized and/or accessed by the interpreter 174 to validate a single, portion of, or collection of data profiles, and replace the validated data profile, portion, or data profiles with the corresponding symbol. The corresponding symbol can then be used for further data processing.

In various embodiments, the dictionary 134 comprises a collection of plural tokens. The dictionary 134 can comprise plural entries in memory with each entry corresponding to a unique token. Each token can correspond to a valid symbol or combination of symbols. The dictionary 134 can be utilized and/or accessed by the interpreter 174 to validate a symbol or combination of symbols, and represent the symbol or combination of symbols with a token. In some embodiments, after forming a token, the interpreter 174 indicates that a piece of non-contextual analysis has been completed.

In various embodiments, the grammar element 136 comprises a set of rules providing contextual meaning to a token or collection of tokens generated by the interpreter 174. The grammar element 136 can be implemented as plural entries in memory wherein each entry corresponds to a unique grammar rule. The grammar element 136 can be utilized and/or accessed by the parser 176 to validate a token or collection of tokens within a particular context. In some embodiments, if a token or collection of tokens received from the interpreter 174 is determined by the parser 176 to be a valid grammar structure, the parser 176 forms a contextual token and indicates that a piece of contextual analysis has been completed.

II-B-2-c. AI and Statistics Algorithms

The creation module 102 can comprise various artificial intelligence (AI) algorithms 140 and statistics algorithms 150. These algorithms can be used during system development, e.g., during development time, as well as during system operation, e.g., during run time. In certain embodiments, the AI and statistics algorithms can be accessed during system operation by the engine module 106 directly or through the sensor profile unit 160. In some embodiments, certain AI and/or statistical algorithms utilized by the interpreter 174 are loaded into the sensor profile unit 160.

During system development, AI and/or statistics algorithms can be used to train the system 100 to recognize certain received data sequences as valid data sequences even though a received data sequence may not be an exact replica of a valid data sequence. In operation, this is similar to recognition of alpha-numeric characters. For example, a character “A” can be printed in a wide variety of fonts, styles, and handwritten in a virtually unlimited variety of penmanship styles and yet still be recognized as the character “A.” For the inventive system 100, in various embodiments, the creation module 102 utilizes AI techniques and algorithms to train the system 100 to recognize approximate data sequences received by the interpreter 174 as valid data sequences. The training can be supervised training, semi-supervised training, or unsupervised training.

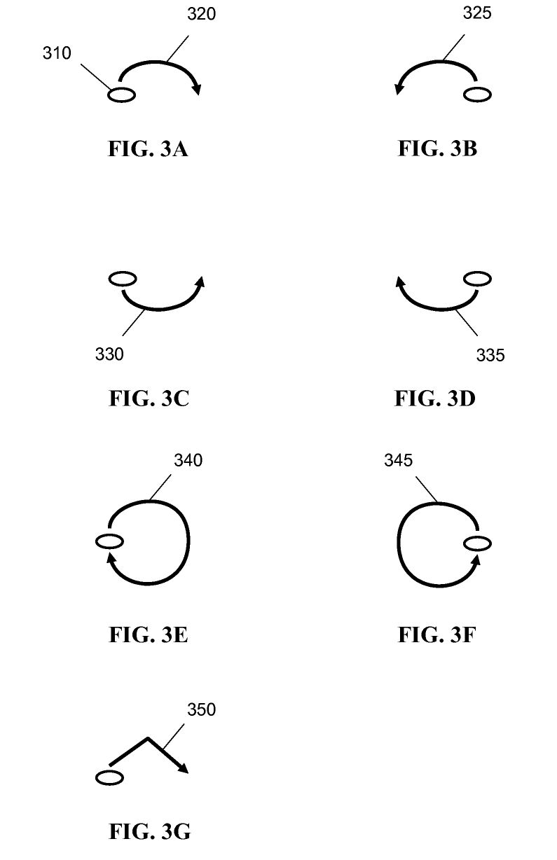

As an example of supervised training and referring to FIG. 3E, a system developer or user can move a motion-capture device 310 having motion-capture sensors in circular motion 340 and record the motion data in memory accessible by the creation unit 102. The circular motion 340 can be repeated by the developer or user, or different individuals, with each new version of the circular motion also recorded. The developer or user can then provide instructions to the creation module 102 that all versions of the recorded circular motions within the training set are representative of a circle pattern. In various embodiments, the creation unit 102 can then use AI techniques and algorithms to identify defining characteristics within the training set. Once defining characteristics are identified, the creation unit 102 can then produce a symbol and/or token and/or grammar rule for inclusion within the data description language 130. After compiling a variety of symbols, tokens, and optionally grammar rules, the data description language 130 along with the sensor input profiles 120, AI algorithms 140 and statistics algorithms 150 can be packaged into a sensor profile unit 160. In certain embodiments, the creation unit 102 provides for testing of a newly compiled sensor profile unit 160 using test data derived either from hardware or from simulation.

During the creation of symbols and tokens, there may be overlap of the created items when additional training sets for other types of data input are used. For example, and referring FIG. 3A and FIG. 3E, the motions 320 and 340 can result in the production of similar symbols, e.g., arc segments, and similar tokens, e.g., quadrant segments, for each motion. At the symbol and token levels, there can then be ambiguity as to what meaning or what command should be associated with the symbolized or tokenized data. In various embodiments, the ambiguity is resolved by the system at the token or grammar level. Referring to English language as an instructive example, 26 symbols can be used to convey an unlimited variety of information. A particular meaning of any one symbol can be clarified at the word (token) level, and the meaning of any one word (token) can be clarified at the sentence level (grammar). Accordingly, for the inventive system 100, the symbols 132 component of the data description language 130 can comprise a small number of valid symbols recognizable to the system, whereas the dictionary 134 and grammar 136 can comprise a large number of tokens and grammar rules. This can be an advantageous architecture for the inventive system 100 in that AI and statistical techniques and algorithms, which can be computationally intensive, are primarily employed at the symbol creation and symbol interpretation phases.

There are a wide variety of AI and statistics algorithms and techniques that can be used during system development and symbol creation. The algorithms and/or methods include, but are not limited to, polynomial curve fitting routines and Bayesian curve fitting routines. These can be used to determine the likeness of two or more records of trial data within a training set. Probability theory and probability densities, e.g., general probability theory, expectations and covariances, Bayesian probabilities, and probability distributions, can also be used during symbol creation. Other techniques employed can include, decision theory for inference of symbols, and information theory, for determining how much information has arrived, relative entropy, and mutual information of a training set. Methods employing linear models for regression can also be used, which include linear combination of input variables, maximum likelihood and least squares, geometry of least squares, sequential learning, regularized least squares, bias-variance decomposition, Bayesian linear regression, predictive distribution, smoother matrix, equivalent kernel and linear smoothers, and evidence approximation. In some embodiments, neural network techniques can be used including multilayer perception, non-fixed nonlinear basis functions and parameterization of basis functions, regularization, mixture density networks, Bayesian neural networks, and error backpropagation. Kernal methods can be employed in which training data sequences, or a subset thereof, are kept and used during prediction or formation of symbols. Additional techniques include probabilistic graphical models for visualization and data structuring, and Markov and Hidden Markov models.

During system operation, the interpreter 174 can utilize AI and statistical algorithms in its association of received data with valid symbols. In certain embodiments, the AI and statistical algorithms are provided with the sensor profile unit 160 and utilized by the interpreter during symbolizing of data sequences within the received data profiles 173. The metadata included with each data profile can guide the interpreter 174 in regards to the type of data and how the data can be handled. In various embodiments, AI and statistics algorithms used by the interpreter provide a measure of tolerance or leniency in the association of one or more valid symbols with a data sequence within the data profile. In various embodiments, the interpreter employs AI classification algorithms and/or methods when associating symbols with received data sequences.

In various embodiments, data profiles are received by the interpreter 174 and reviewed. Classification methods are used by the interpreter 174 to determine whether data sequences within a data profile are representative of one or more symbols residing within the system's symbols set. Each symbol can comprise a block of information that offers parameters which must be met in order for a data sequence to qualify as the symbol. In various aspects, the parameters offered by each symbol are consulted by the interpreter during the process of classification. A number of statistical and probabilistic methods can additionally be employed during the classification of data sequences. The statistical and probabilistic methods can be used to determine if a data sequence is sufficiently similar to a valid symbol, e.g., falls within tolerance limits established during symbol creation. For data sequences which are deemed by the interpreter 174 to be sufficiently similar to a valid symbol, a symbol value can be returned for further processing by the interpreter. Data sequences which are not found to be sufficiently similar to any symbol can be discarded by the interpreter.

There exists a wide variety of AI and statistics algorithms and techniques that can be used for classification of data sequences received by the interpreter. The algorithms and techniques include polynomial curve fitting and/or Bayesian curve fitting. These can be used to determine the similarity of two or more data sequences. Additional methods can include the use of probability theory and probability densities, e.g., general probability theory, expectations and covariances, Bayesian probabilities, and probability distributions. In some embodiments, elements of decision theory are used during classification of received data. In certain embodiments, posterior probabilities provided by the sensor profile unit 160 during an inference stage are used to make a classification decision.

In some embodiments, linear models are used for classification. The linear models can include discriminant functions, e.g., using two or more classes, least squares, Fisher's linear discriminant, and/or perception algorithm. The linear models can also include probabilistic generative models, e.g., continuous inputs and/or maximum likelihood solution. In some embodiments, the linear models include probabilistic discriminative models such as fixed basis functions, least squares, logistic regression, and/or Probit regression, as well as Laplace approximation, and/or Bayesian logistic regression methods including predictive distribution. In certain embodiments, techniques and methods developed for neural network analysis can be employed during classification of data sequences received by the interpreter 174. Algorithms based on neural network techniques can include multilayer perception, non-fixed nonlinear basis functions and parameterization of basis functions, regularization, mixture density networks, Bayesian neural networks, error backpropagation, and/or Jacobian and Hessian matrices. In various embodiments, the system 100 uses statistical and probabilistic methods to determine whether data sequences received by the interpreter 174 are sufficiently similar to one or more symbols within the system's symbol set and to correspondingly classify the data sequence.

An advantage of using AI and statistics algorithms during system development and system operation is to adapt the system to accommodate a wide variety of versions of data sequences created by different system users or operators. In various embodiments, AI and statistical algorithms, e.g., machine learning, are employed during system development to generate components or attributes for symbol entries that indicate allowable “similarity” of received data. Training sets can be used during system development to construct symbols. Symbol entries can indicate allowable similarity by including a classification element or component, which can be evaluated during the decision phase of symbol interpretation.

In various embodiments, AI and statistical algorithms, e.g., decision theory, are employed during system operation, and in particular for data interpretation and symbol recognition, to utilize the components or attributes in determining symbol matches. Much like recognition of a wide variety of unique handwriting styles, the inventive interpretation and processing system 100 can recognize a variety of data sequence “styles” which may be intended by one or more system operators to execute a unique command. It will be appreciated that the same algorithms and methods can be employed in the system 100 at higher-level interpretation, e.g., interpretation of symbols and recognition of tokens or interpretation of tokens and recognition of grammar rules, once a symbol and token streams are formed. In certain embodiments, the inventive system 100 uses AI and statistics algorithms during symbol creation and symbol recognition from data sequences received by the interpreter, and the system 100 uses language processing techniques, e.g., database searching methods, information retrieval, etc., after symbol recognition.

II-B-2-d. System Development Kit 105

In various embodiments, the creation module 102 includes a system development kit (SDK) 105. The SDK can be used by a developer or user to configure the system 100 for a particular desired operation, e.g., to recognize certain raw input data 117 and generate output commands 182 and/or 184 tailored for a particular application 190. In various aspects, the SDK 105 comprises an interface allowing access to and editing of various components within the creation module 102. The SDK can be implemented as software or firmware executing on a processor.

As an example, the SDK 105 can be used to define a new sensor input profile 200 for a new input device providing motion input 112 or non-motion input 114. The SDK 105 can provide an interface within which a system developer or user can define a new sensor input profile, and optionally define one or more symbols, dictionary tokens and/or grammar rules that are associated with data received from the new input device. The SDK 105 can then store the new information in the sensor input profiler 120 and data description language 130 for later use.

In some embodiments, an external application 190 and/or hardware input devices 112, 114 can dictate which components of the system must be edited and how they are edited. In some embodiments, an application 190 and hardware devices work together effectively with an agreed-upon operational configuration. The operational configuration can be defined with the use of the SDK and later stored in the sensor profile unit 160.

In some embodiments, training sets may be used in conjunction with the SDK to assist in system development. As an example, one or more input devices may be operated multiple times in a similar manner to provide plural similar data blocks as an example data set for a particular raw input data pattern, e.g., a motion gesture. The SDK 105 may record the similar data blocks and ascertain the quality of the example data set, e.g., receive a quality verification input from the user or developer, or determine whether the data blocks are similar to within a certain degree, e.g., within ±5% variation, ±10% variation, ±20% variation. The SDK 105 may then search and/or evaluate the example data set to ascertain one or more defining characteristics within the training set. The defining characteristics can then be used by the SDK to form one or more new data description language elements, e.g., symbol entry, dictionary entry, and/or grammar entry, for the particular input pattern.

As an example of the use of training sets for symbol construction during system development, the construction of two symbols A and B is described. It will be appreciated from this example that the constructed symbols themselves provide meaning, e.g., instruction, to the engine module 106 which can be utilized during interpretation of data 173. In this example, a motion-capture device module 110 is operated in a particular manner to produce motion input 112 and/or non-motion input 114 which is provided to the engine module 106. The particular manner of operation is repeated multiple times to form a training set. The training set can be evaluated by the creation module 102 from which it may be found that an X-axis accelerometer within the device module 110 outputs acceleration data that exceeds a value of a₁ for all data sets within the training set. A corresponding symbol A can then be constructed as A={“accelerometer_x”, “threshold”, “a₁”}. This symbol can then provide the following “meaning” to the engine module 106 or interpreter 174: evaluate received data from the X-axis accelerometer using a threshold function and determine whether a₁ has been achieved. If the evaluation returns a true state, the symbol A can be associated with the data. Continuing with the example, the evaluation of the training set may also reveal that the acceleration value is followed substantially immediately, e.g., within n data points, by a standard deviation of about sd between a measured Y-axis gyroscope value and its zero (still) value. A corresponding symbol B can then be constructed as B={“gyroscope_y”, “standarddeviation”, “sd”, “within”, “n”}. This symbol can provide the following “meaning” to the engine module 106 or interpreter 174: evaluate the received data from the Y-axis gyroscope using a standarddeviation function and look for a value of sd being achieved within n data points of an A symbol. If the evaluation returns a true state, the symbol B can be associated with the data. Continuing with the example, the symbol concatenation AB can be identified as a token associated with the particular manner of operation of the device module 110. A token comprising AB would provide the necessary meaning or instructions to the engine module 106 to correctly interpret the received data and identify it with the particular manner of operation.

In some embodiments, the SDK 105 employs Bayes' theorem to generate statistical data which can be incorporated into the sensor profile unit 160 and used by the interpreter 174 and/or parser 176 during decision phases of data interpretation. As an example, Bayes' theorem can be represented as

$$P ( A \vert B ) = \frac{P ( B \vert A ) \times P ( A )}{P ( B )} \qquad EQ . ( 1 )$$

where P(A|B) represents the conditional or posterior probability that a motion data input is a particular symbol, e.g., “S₁”, given that the motion data input has a particular characteristic; P(A) represents the prior probability that the motion data input is the particular symbol regardless of any other information; P(B) represents the prior probability that a randomly selected motion data input has the particular characteristic; and P(B|A) represents the conditional probability that the particular characteristic will be present in the motion input data if the motion input data represents the particular symbol. In certain embodiments, P(A), P(B), and P(B|A) are determined during system development using the SDK. For example, P(B|A) can be determined from a particular training set having motion intended to represent a particular symbol. P(A) and P(B) can be determined based upon the total distinguishable motion entries in the creation module 102 that are used for a particular application 190. The values of P(A), P(B), and P(B|A) can be provided to the sensor profile unit 160 and used by the interpreter 174 and/or parser 176 during run time to assist in determining whether a particular motion substantially matches a particular symbol. In certain embodiments, the interpreter 174 evaluates Bayes' theorem for data profiles representative of motion input and selects a best-match symbol based on a conditional probability determined by Bayes' theorem.

The SDK 105 can also be used to configure the sensor profile unit 160 based upon newly developed data profile description language elements. In certain embodiments, the SDK 105 can then be used directly to test the new sensor profile unit 160 on test data, wherein the test data can be provided either directly from hardware input or through simulated input, e.g., computer-generated input. It will be appreciated by one skilled in the art of artificial intelligence and machine learning that training sets may be used in various manners to achieve a desired functionality for a particular component within the system 100.

### II-B-3. Engine Module 106

In various embodiments, processing of raw input data 117 is carried out within the engine module 106. The engine module can comprise a sensor profile unit 160, a data profile processor 172, an interpreter 174, and optionally a parser 176. The engine module 106 can be implemented as software and/or firmware code executing on a processor. In various embodiments, the engine module 106 receives raw input data 117 which can comprise motion and non-motion data, processes the received raw data and provides output context-based (contextual) commands 182 and/or non-context-based (non-contextual) commands 184 to an application 190. In certain embodiments, the engine module 106 receives data 185 fed back from the application 190.

II-B-3-a. Sensor Profile Unit 160

In certain embodiments, the sensor profile unit 160 contains one or more sets of related sensor input profiles 200 and symbols, dictionary tokens and grammar rules defined within the data description language 130, and optionally, algorithms and information provided by the AI algorithms 140 and statistics algorithms 150. Each set can represent a particular configuration for use during system operation. In some embodiments, the sensor profile unit 160 is implemented as software and/or firmware executing on a processor, and may additionally include memory in communication with the processor. In some embodiments, a sensor profile unit 160 is not included with the system 100, and the system's engine module 106 accesses certain components within the creation module 102 during operation.

In certain embodiments, the sensor profile unit 160 comprises compiled input from the creation module 102. In certain embodiments, the sensor profile unit 160 comprises non-compiled input from the creation module 102. The sensor profile unit 160 can be in communication with the data profile processor 172, the interpreter 174, and the parser 176, so that information may be exchanged between the sensor profile unit 160 and any of these components. In some embodiments, the sensor profile unit 160 is in communication with an external application 190 via a feedback communication link 185. The application 190 can provide feedback information to the engine module 106 through the sensor profile unit 160. As an example, based upon commands received by the application 190 from the engine module 106, the application may activate or deactivate certain sets or particular configurations within the sensor profile unit 160.

In various aspects, the grouping of sensor input profiles 200, symbols, dictionary tokens and grammar rules, etc. into sets or particular configurations within the sensor profile unit 160 creates an adaptive module which is associated with a particular device module 110, e.g., a certain set of hardware devices and data input from those devices. In some embodiments, more than one adaptive module is established within the sensor profile unit 160. Each adaptive module can be readily accessed and used by the system 100 to efficiently process data input received from a particular device module 110 and provide output required by an external application 190. In some embodiments, the sensor profile unit 160 further includes certain artificial intelligence algorithms 140 and/or statistical algorithms 150 which are tailored to a particular input 112, 114, application 190, and engine 106 configuration.

There are several advantages to utilizing a sensor profile unit 160 within the interpretation and processing system 100. One potential benefit can be a reduced redundancy of data. In certain embodiments, the sensor profile unit 160 comprises a compilation of elements from the sensor input profiler 120, the data description language 130, the AI algorithms 140, and statistics algorithms 150 that are sufficient for the engine module 106 to operate certain received data inputs and data types. In some cases, there can be overlap of compiled element use for different data inputs, e.g., one compiled element may be used during data profiling or data interpretation for X-, Y-, or Z-axis accelerometer data. In some embodiments, pointer mechanisms can be used to refer to a common element and eliminate the need to store multiple copies of the element in memory. This can reduce memory usage on a hard disk or in RAM. By compiling relevant elements from the creation module 102 into the sensor profile unit 160, data processing speed can be increased since access to the creation module 102 is not needed during run time.

Another benefit can be packaging of particular modules having separate but related functionalities. One or more packaged modules can be provided within a sensor profile unit 160, allowing ready access and interchangeability during system operation. In certain embodiments, a sensor profile unit 160 comprises plural packaged modules having separate but related functionalities, e.g., a “sword slashes” module, a hand-gesture-controlled operating-system module, a temperature-control module, a robotics image-recognition module. In some embodiments, the packaged modules can be small in size and loaded on-the-fly during system operation by an application 190, e.g., loaded into the engine module 106 upon issuance of a sensor profile package selection command through feedback communication link 185, or by a user of the system, e.g., upon selection of a sensor profile package corresponding to an icon or text presented within a list to the user. The newly loaded sensor profile package can alter or improve system operation. Another advantage of utilizing a sensor profile unit 160 includes more facile debugging of a configured system 100. In certain embodiments, system debugging tools are carried out within only the engine module 106 for each sensor profile package to test each package as it is configured. Local debugging within the engine module 106 can reduce the need for system-wide debugging.

In some embodiments where information, e.g., one or more packaged modules, is loaded into the sensor profile unit 160 from the creation module 102 for subsequent use by components within the engine module 106, the information is compiled prior to loading or upon loading into the sensor profile unit 160. In some embodiments, the information is loaded uncompiled. In some embodiments, the information may be loaded at compile time. In some embodiments, the information is loaded at run time.

The creation and use of a sensor profile unit 160 is not always required for operation of the system 100. In some embodiments where hardware configurations and/or applications 190 may change rapidly, the engine module 106 may access directly information from any one or all of sensor input profiler 120, data description language 130, AI algorithms 140, and statistics algorithms 150. In some embodiments, direct access to these creation module 102 components can provide accelerated flexibility of the system for certain uses, e.g., testing and reconfiguring of input devices and/or applications 190.

II-B-3-b. Data Profile Processor 172

In various embodiments, the data profile processor 172 operates on a received raw input data stream 117 and produces a stream of data profiles 173. The data profile processor can be implemented as software and/or firmware executing on a processor. The data profile processor 172 can be in communication with the sensor profile unit 160, or in some embodiments, in communication with components within the creation module 102.

In various aspects, the data profile processor 172 associates data blocks or segments in the received raw data stream 117 with appropriate sensor input profiles 200. As an example, the data profile processor 172 can monitor the incoming data stream for configuration ID's associated with the received data. Upon detection of a configuration ID, the data profile processor 172 can retrieve from the sensor profile unit 160 a corresponding sensor input profile 200 for the data segment. The data profile processor 172 can then attach the retrieved sensor input profile to the data segment to produce a data profile 173. This process of producing data profiles 173 utilizes incoming input data from the raw data stream 117 and sensor input profiles 200 to generate higher-level data profiles which are self-describing. These self-descriptive data profiles represent higher-level metadata. In some embodiments, a data profile 173 contains a single input data type or data segment and metadata associated with it. In some embodiments, a data profile 173 can contain any number of input data types and the metadata associated with them.

In some embodiments, data can be provided to the data profile processor 172 from multiple device modules 110, e.g., multiple motion-capture devices. In such embodiments, the data profile processor 172 can generate a stream of data profiles using plural computational threads. For example, each computational thread can process data corresponding to a particular device module.

Self-descriptive information within a data profile aids in subsequent interpretation by the interpreter 174 and parsing by the parser 176, so that interpretation and parsing can be carried out more efficiently than if the data were only raw data provided directly from the input hardware. In various embodiments, the data profiles can contain information that guides the interpreter 174 and/or parser 176 in their processing of the data. As an example, the metadata can establish certain boundary conditions for how the data should be handled or processed. The metadata can provide information which directs the interpreter 174 or parser 176 to search a particular database for a corresponding token or grammar rule.

II-B-3-c. Data Profiles

Data profiles 173 are generated by the data profile processor 172. In various embodiments, a data profile 173 comprises a block of data in which a selected data segment received in the raw data stream 117 is associated with a sensor input profile 200. In some embodiments, a data profile contains a copy of information provided in a sensor input profile 200. In some embodiments, a data profile contains a pointer which points to a location in memory where the sensor input profile resides. In various embodiments, a data profile 173 is a higher-level data block than the corresponding received raw input data segment. In certain aspects, a data profile 173 comprises metadata. In certain aspects, data profiles are data which describes itself and how it relates to a larger expectation. In various embodiments, data profiles 173 are provided to the interpreter 174 for non-context-based analysis and recognition. II-B-3-d. Interpreter 174

In various embodiments, the interpreter 174 converts one or more data profiles received in a data profile stream 173 into one or more non-contextual tokens which are output in a non-context token stream 175. The interpreter 174 can be implemented as software and/or firmware executing on a processor. The interpreter 174 can be in communication with the sensor profile unit 160, or in some embodiments, in communication with components within the creation module 102. In some embodiments, one received data profile is converted to one non-contextual token. In some embodiments, plural received data profiles are converted to one non-contextual token. In some embodiments, one received data profile is converted to plural non-contextual tokens. In certain embodiments, the interpreter 174 converts data profiles to non-contextual commands recognizable by an application 190, and outputs these commands in a non-contextual command stream 184 to the application.

In various embodiments, the interpreter 174 receives data profiles and utilizes symbol 132 and dictionary 134 data from the data description language 130 to create a stream 175 of higher-level interpreted tokens. In various aspects, to convert data profiles to non-contextual tokens and/or non-contextual commands, the interpreter 174 uses information provided from the symbols 132 and dictionary 134 modules. In some embodiments, the information is accessed directly from the modules within the data description language 130. In some embodiments, the information has been loaded into or compiled within the sensor profile unit 160 and is accessed therein. In certain embodiments, additional information or algorithms provided by the AI algorithms module 140 and statistics algorithms module is utilized by the interpreter 174. This information can be accessed directly from the modules, or can be accessed from the sensor profile unit 160. In various aspects, the interpreter 174 utilizes multi-processing techniques and artificial intelligence techniques, understood to those skilled in the art of computer science, to analyze, interpret, and match various sequences, combinations and permutations of incoming data profiles to certain elements of the data description language 130 deemed most relevant. The interpreter 174 then produces one or more non-contextual tokens and/or commands based upon the match. In certain embodiments, the non-contextual tokens are passed to the parser 176 for further processing. In certain embodiments, the non-contextual commands are directly provided to, and used by, the application 190.

In various aspects, the interpreter 174 determines best matches between received data profiles and symbols provided from the symbols module 132. If a best match is found, the interpreter produces a symbol in a symbol data stream. If a best match is not found for a data profile, the data profile may be discarded. The interpreter 174 can further determine a best match between sets, subsets or sequences of symbols in its symbol data stream and tokens provided from the dictionary 134. If a best match is found, the interpreter produces a non-contextual token or command for its output non-context token stream 175 or non-context command stream 184. If a best match is not found for a set, subset or sequence of symbols, one or more symbols in the symbol data stream may be discarded.

In some embodiments, one or more data profile streams can be provided to the data interpreter 174 from multiple device modules 110, e.g., multiple motion-capture devices. In such embodiments, the interpreter 174 can process the data profiles using plural computational threads. For example, each computational thread can process data corresponding to a particular device module.

In certain embodiments, the interpreter 174 utilizes multi-threading and multi-processing techniques when available on the platform upon which the engine module 106 is running, e.g., 2 threads, 2 processors or 4 threads, 4 processors for Intel Core 2; 8 threads, 9 processors for IBM Cell; 3 threads, 3 processors for XBOX360. It will be appreciated that other multi-thread, multi-process configurations may be used on other platforms supporting multi-threading and/or multi-processing. The interpreter 174 can use any number of threads and processors available to identify possible matches between the incoming data profiles and symbols within a symbol set provided by the symbol module 132. In one embodiment, the interpreter 174 can have a single thread associated which each symbol, that thread being responsible for identifying matches between data profiles and the symbol. A similar concept can be used in the identification of non-contextual tokens from the symbols found, e.g., individual threads can be assigned to each token. In some embodiments where plural input devices provide data to the engine module 106, e.g., multiple motion-capture devices providing motion and/or non-motion data, separate threads may be associated with each of plural devices. The benefit of using multi-threading and multi-processing techniques is faster interpretation as well as the ability to utilize scalable computing platforms for more complex analyses.

II-B-3-e. Parser 176

In various embodiments, the parser 176 receives a stream on non-contextual tokens from the interpreter 174 and processes the tokens to generate a stream of context-based commands 182 which are recognized by an application 190. The parser 176 can be implemented as software and/or firmware executing on a processor. The parser 176 may be in communication with sensor profile unit module 160, or in some embodiments, in communication with components within the creation module 102. In various aspects, the parser 176 utilizes grammar rules provided from the grammar element 136 in its analysis and processing of the non-contextual tokens to produce higher-level contextual tokens, termed “sentences.”

Like the interpreter 174, the parser 176 can also utilize multi-processing and artificial intelligence techniques to interpret, analyze, and match various sequences, combinations and permutations of incoming non-contextual tokens to certain grammar rules deemed most relevant. In certain embodiments, parsing is used where precise information and analysis of the original input data stream 117 is desired. In certain embodiments, the parser 176 provides meaning to received tokens which extends beyond the information provided by the individual tokens, e.g., context-based meaning. Where one token may mean something by itself, when received with one or more tokens it may have a different or expanded meaning due to the context in which it is presented to the parser 176.

Similar to the interpreter 174, the parser 176 can also take advantage of multi-threading and multi-processing techniques when available on the platform upon which the engine module 106 is running, e.g., 2 threads, 2 processors or 4 threads, 4 processors for Intel Core 2; 8 threads, 9 processors for IBM Cell; 3 threads, 3 processors for XBOX360. The parser 176 can use plural threads and processors available to identify possible semantic relationships between the incoming tokens based upon rules provided from the grammar element 136. In one embodiment, the parser has a single thread associated which each grammar rule, that thread being responsible for identifying a proper semantic relationship between the received non-contextual tokens. When a grammar-validated semantic relationship is identified for a set, subset, or sequence of received non-contextual tokens, the parser 176 can produce a command, recognizable by an application 190, associated with the identified set, subset or sequence of non-contextual tokens. When a grammar-validated semantic relationship is not identified, the parser 176 can discard one or more non-contextual tokens. Context-based commands produced by the parser 176 can be provided in a context-based command stream 182 to an application 190.

In certain embodiments, parsing is not required and is omitted from the engine module 106. In certain embodiments, the system 100 is configured to use an interpretative data-processing engine module 106 which produces non-contextual tokens and/or commands. The non-contextual tokens and/or commands can be provided as output from the engine module 106, and used as input to an application 190 adapted for external control.

### II-B-4. System Adaptability

It will be appreciated from the preceding descriptions that the modular and configurable sensor input profile 160, interpretation 174 and parsing 176 elements within the engine module 106 allow for a large number and/or combination of input device types within the device module 110. These elements can be readily configured at development time using the creation module 102 to provide an appropriate system configuration to operate a controlled application 190 without changing the underlying architecture of the system 100 or the external application 190. In certain embodiments, the sensor profile unit 160 is configurable at development time and reconfigurable at run time. For example, a package module within the sensor profile unit 160 can be activated or de-activated based upon information fed back to the sensor profile unit 160 from an application 190 through communication link 185.

In various aspects, the inventive system 100 enables facile and rapid development and testing of new applications for certain pre-existing or new hardware input devices while allowing for the hardware and/or external applications to change over time. Changes in hardware and/or external applications can be accommodated by the system 100 without having to recreate the underlying analysis and recognition algorithms, e.g., the underlying profile processing, interpretation and parsing algorithms can remain substantially unaltered whereas input profiles and data description languages can be updated as necessary. In this manner, a developer can augment certain system components, e.g., sensor input profiler 120, data description language 130, and/or the sensor profile unit 160, to adapt the system 100 to provide control to an application 190, accommodating changes in hardware.

### III. Applications

The following usage examples illustrate how the interpretation and processing system 100 can be incorporated in or used with a wide variety of applications.

### III-A. Operating Systems and Control

Current methods for interfacing with an operating system are based on user-input via buttons, keyboard and 2D cursor devices, e.g., mouse, trackpad, or touchpad. As operating systems become more complex, moving to three dimensions can be beneficial. Having the ability to control a virtual 3D space using human motion will be a natural extension of current input control methods. In certain embodiments, the inventive system 100 provides for adaptation of 2D operating systems to 3D operating systems by altering and/or extending a sensor profile unit 160 associated with operating system control, e.g., by modifying the 2D context of the grammar within the data description language 130 to a 3D grammar rules set.

In some applications, system control can be based upon human motion and/or human biological information. As an example, a human can operate a motion-capture device to control a system. The motion-capture device can be a hand-held device or a device which senses motion executed by a human operator. The motion-capture device can provide output data representative of motion patterns or gestures executed by the human operator. The output data can be provided as raw data input to the system's engine module 106, and interpreted and processed to control an external application 190, e.g., an operating system of an electronic apparatus, a virtual reality device, a video game, etc. In some embodiments, human biological information such as, but not limited to, pulse, respiration rate, blood pressure, body or appendage temperature, bio-electrical signals, etc., can be monitored with appropriate sensors and provide data to the system's engine module 106. The biological information can be interpreted and processed and used to alter system operation in a manner which corresponds to the biological state of the human operator.

### III-B. Sensor Networks & Robotics

Advanced robotics technologies require the use of sensor networks, or a variety of sensors and inputs to gain information about the environment and/or objects within the environment. A robot might require vision sensors, e.g., photodetectors, cameras, etc., motion sensors, e.g., accelerometers, gyroscopes, interferometers, position sensors, e.g., infrared, magnetometers, GPS, touch sensors, e.g., piezo-electric switches, pressure sensors, strain gauges, other sensors, environmental information, control signals, non-sensor information, and other inputs, etc. An objective of robotics is to implement a robot that can imitate and function much like humans. Humans have a variety of biological sensors that are used in conjunction with each other to gain information about their local environment. Based on a context, e.g., a vision and a smell in conjunction with a noise, a human may determine in less than a second that a particular event in the environment is occurring. At present, robotic functioning is significantly inferior to human functioning in terms of perceiving a wide variety of environments.

The inventive interpretation and processing system 100 can provide solutions to certain robotics problems by allowing a robotic developer to create a data description language 130 that identifies certain permutations, sequences and/or combinations of data which occur frequently in an environment and configure them in a robotics sensor profile unit 160. In some embodiments, pattern-recognition modules are incorporated in a robotics sensor profile unit 160. For example, a pattern-recognition module can be developed for image patterns, e.g., images recorded with a CCD camera by a robotics system. Another pattern-recognition module can be developed for motion patterns, e.g., motion patterns executed by objects external to the robotics system yet sensed by the robotics system. The engine module 106 can readily access the robotics sensor profile unit 160 during operation of the robotics system and utilize information therein to interpret and process a wide variety of information received from sensors in communication with the robotics system. The developer may continue to build upon the data description language and update the sensor profile unit to meet the challenges of more complex tasks, while developing algorithms that can process the information more efficiently and quickly. In some embodiments, utilizing a more complex data description language, the parsing process, AI algorithms, and statistical algorithms provides higher-level functioning for robotics control systems and sensor networks.

### III-C. Sports Motion Capture

Most sporting activities require specific human motions, and generally, high precision and accuracy of athletic motions characterize top-caliber athletes. Multi-dynamic body motions of athletes and motions of athletic implements, e.g., golf clubs, racquets, bats, can be captured with motion-capture devices, e.g., accelerometers, gyroscopes, magnetometers, video cameras, etc., and the motion information provided as raw data input to the inventive system 100. The system can be used to interpret, process, and analyze the received motion data and provide instructive information to an athlete. In such an embodiment, the external application 190 can be a software program providing analytical information, e.g., video replays, graphs, position, rotation, orientation, velocity, acceleration data, etc., to the athlete. Motion capture and analysis can be useful to athletes in a wide variety of sports including, but not limited to, golf, baseball, football, tennis, racquetball, squash, gymnastics, swimming, track and field, and basketball.

As one example, the inventors have developed an iClub Full Swing System and an iClub Advanced Putting System which utilize a version of the interpretation and processing system 100 for both motion-based user interaction and control, and golf swing capturing and analysis. Real-time interpretation is utilized for user interaction and control. The user can rotate a club having a motion-capture device clockwise about the shaft to perform a system reset or counterclockwise to replay a swing. Interpretation is also utilized to determine whether or not a swing was in fact taken, e.g., to validate a motion pattern representative of a golf swing. A data description language 130 for golf has been developed to allow for accurate detection of the swinging of various types of golf clubs including the putter.

The inventors have also developed an iClub Body Motion System which utilizes a golf body mechanics data description language 130 in conjunction with a sensor profile unit 160 to interpret and process biomechanics data throughout a golfer's swing. In certain embodiments, this system utilizes a simplified data description language, e.g., one comprising symbols which include only “threshold” and “range” functions, and provides for control of an audio/visual feedback system. In certain aspects, this system only determines whether certain symbols are present in the interpreted data, regardless of order of the validated symbols.

### III-D. Motion-Based Gaming

The inventive interpretation and processing system 100 can be used as a platform for quickly developing a robust motion-based user experience for gaming applications. Recently the Nintendo® Wii™ has created a motion-based controller for their video game system. The inventive interpretation and processing system 100 can provide further advancement of this genre of gaming by permitting use of more advanced motion-based controllers and other gaming applications, e.g., the Motus Darwin gaming platform, with existing and new gaming applications. With new motion-based controllers and new gaming applications, the inventive interpretation and processing system 100 can provide for more immersive gameplay in advanced gaming applications.

In some embodiments, as costs decrease more sensors can be included with game controllers, providing information and data input that has not yet been utilized. As an example, human biological information, e.g., temperature, pulse, respiration rate, bio-electrical signals, etc., can be monitored and provided as raw input data to the gaming systems engine module 106. Data description languages 130 and/or sensor profile units 160 developed for existing devices can be readily extended to incorporate additional sensor information to enhance gameplay experience.

### III-E. Physical Therapy & Body Tracking

The field of physical therapy typically utilizes older, manual technology (goniometer/protractor) to record measurements. Information gathered about body motion in this manner is prone to a great amount of error. The use of motion-based technologies and the inventive interpretation and processing system 100 can provide accurate measurement and analysis of body motions. A custom data description language 130 and optionally a sensor input unit 160 for physical therapy can be developed specifically for physical therapy applications. In some embodiments, the system 100 can include audio/visual feedback apparatus, e.g., equipment providing audio and/or video information about patient motions to a patient or therapist. A motion- or body-tracking application 190 which utilizes data interpretation and processing in accordance with the inventive system 100 can support an exercise-base rehabilitation program for a patient. Such a system can be used by physical therapists to diagnose and track patient recovery with improved scrutiny over conventional methods.

### III-F. Additional Applications

As can be understood from the examples above, the inventive interpretation and processing system 100 has utility in various applications where a plurality of sensors provide information about an object, subject or environment. It will be appreciated that potential applications also exist in, but are not limited to, the fields of healthcare, signed language, and audio and cinematography. In the field of healthcare, the system 100 can be used to interpret and process data received from patient monitoring, e.g., vital signs, specific medical indicators during surgery, body motion, etc. In the field of signing, the system 100 can be used to interpret and process data received from a motion-capture device operated by a person. In certain embodiments, the system 100 can translate the signed language into an audio or spoken language. In certain embodiments, the system 100 can be used to interpret and process data received from military signed communications. In the fields of audio and cinematography, the system 100 can be used to interpret and process data received from audio, visual and/or motion-capture devices. In certain embodiments, the system 100 can be used for audio analysis and/or voice recognition. In certain embodiments, the system 100 can be used in controlling a virtual orchestra or symphony. For example, a MIDI device can be time synchronized with a conductor's baton having a motion-capture device within or on the baton. In certain embodiments, a motion-capture device can be used in conjunction with the inventive system 100 to create image content for a cinemagraphic display. For example, a data description language 130 can be developed which defines certain images to be associated with certain motions. In some embodiments, camera tracking and/or control as well as image analysis can be implemented using the inventive system 100.

### IV. Examples of Data Interpretation and Processing

The following examples illustrate certain embodiments of the methods and operation of the inventive interpretation and processing system 100. The examples are provided as an aid for understanding the invention, and are not limiting of the invention's scope.

### IV-A. Example 1

This Example provides a basic and brief overview of how data can be received, interpreted and processed within the engine module 106. The Example describes how a simple motion, a circle, is captured with a motion-capture device and processed to output a command to an external application 190. The Example also illustrates that context-based meaning can be associated with raw data input.

User Action: A motion-capture remote-control device is moved in a circle while playing a video game.

Raw Data Input: Nine data sequences of motion data (three data sequences per axis of an x, y, z spatial coordinate system) are provided from the motion sensors within the controller. In some embodiments, the data can be preprocessed on the controller before being provided to the engine module 106 as raw data input 117. The preprocessing can include formatting of the data for transmission.

Data Profiling: The data is received by the engine module 106 and processed by the data profile processor 172. The data profile processor associates an input profile 200 with each data sequence to create a stream of data profiles 173.

Symbol Association: After being profiled, the interpreter 174 receives the stream of data profiles 173. As the interpreter processes the received data profiles, a series of “curve” symbols, e.g., Curve1, Curve2, . . . , Curve4096, can be associated with the data by the interpreter 174. In various embodiments, the interpreter consults the sensor profile unit 160 and/or the data description language 130 to determine the correct associations. The curve symbols can be associated with three-dimensional curve components, with loose boundary condition requirements, that form curves in 3D space. The interpreter 174 can then produce a stream of symbols based upon the associations.

Token Association: The interpreter 174 can then process the symbol stream and determine whether tokens can be associated with the symbols. In various embodiments, the interpreter consults the sensor profile unit 160 and/or the data description language 130 to determine the correct associations. An example set of non-contextual tokens for the data set may comprise QCQ1, QCQ2, QCQ3, QCQ4. These tokens may have the following meanings: Quarter Circle Quadrant 1 (QCQ1), Quarter Circle Quadrant 2 (QCQ2), Quarter Circle Quadrant 3 (QCQ3), Quarter Circle Quadrant 4 (QCQ4). The interpreter can associate and produce an output token, e.g., QCQ1, when it receives and recognizes a particular symbol sequence, e.g., the symbol sequence Curve1 Curve2 . . . Curve 1024.

Output Tokens: In this example, the interpreter can output the following non-contextual token stream: QCQ1 QCQ2 QCQ3 QCQ4. In some embodiments, the token stream is provided to the parser 176 for further processing. In some embodiments, the tokens may comprise commands recognizable to the external application 190 and be provided to the external application. In some embodiments, the interpreter 174 may further process the tokens to associate commands, recognizable by the external application 190, with the tokens. The commands can then be sent in a command data stream 184 to the application 190.

Context: In certain embodiments, a thread executing by the parser 176 can monitor the received non-contextual token stream 175 for data associated with the following grammar rule: (circle right)=(four quarter circles) where the quarter circles are received in “right” sequential order. For example, for any and each two sequential quarter circles (QCQm, QCQn) received in a group of four, (n−m)=1 or −3, where m and n may be symbol indices.

Parser output: Based upon a grammar rule, the parser 176 can identify the context in which the quarter circle tokens were presented. In various embodiments, the parser consults the sensor profile unit 160 and/or the data description language 130 to determine a correct grammar rule to associate with the token sequence and thereby determine the correct context. Continuing with the example, each quarter circle was received in the context of a right-handed or clockwise drawn circle. The parser can then output a context-based command associated with “circle right” recognizable by the application 190.

Command Association: An application-recognizable command corresponding to a recognized token and/or token sequence or context can be associated by a system user, a system developer, the engine module 106, or the application 190. In some embodiments, the system user or system developer associates one or more commands with a token and/or token sequence or context. For example, the user or developer can associate commands during a set-up phase or development phase. In some embodiments, the engine module 106 and application 190 can associate commands, e.g., select commands from a list, based upon system history or application status 190.

Application: In various embodiments, the application 190 receives a command associated with a validated token, token sequence and/or context. Continuing with the example, after validation of the token sequence QCQ1 QCQ2 QCQ3 QCQ4 by the parser 176, the application 190 receives a recognizable command associated with the context “circle right.”

### IV-B. Example 2

This Example provides a more detailed description of data interpretation and processing methods employed by the inventive system 100. In this Example, motion and non-motion data are processed by the system's engine module 106. The particular embodiment used in this Example is directed to a video-game controller application, but is meant in no way to be limiting. In view of the illustrative embodiment, it will be appreciated by one skilled in the art that the inventive system and methods are adaptable to various applications involving control, operation, or remote control of electronic or electro-mechanical devices, as well as applications involving processing and interpretation of various types of received data streams.

Referring now to FIGS. 3A-3G, methods for interpreting and processing data streams are described. In various embodiments, the inventive system and methods are used to convert motions of a motion-capture device 310 into commands or instructions used to control an application 190 adapted for external control. As an example, each of the motions depicted as arrows in FIGS. 3A-3G can correspond to one or more particular commands used to control the application 190. In addition to motion input, the system's engine module 106 can also receive non-motion input, e.g., input data derived from non-motion devices such as keyboards, buttons, touch pads and the like.

In certain embodiments, a motion-capture device 310 can transmit information representative of a particular motion 320 as motion data to the system's engine module 106. The engine module 106 can receive the motion data as motion input 112. The motion data can be generated by one or more motion-sensing devices, e.g., gyroscopes, magnetometers, and/or accelerometers. The motion-capture device 310 can also transmit non-motion data, e.g., data generated from button presses, joysticks, digital pads, optical devices, etc., in addition to the motion data. The non-motion data can be received by the system's engine module 106 as non-motion input 114. In some embodiments, the motion input 112 and/or non-motion input 114 are received as raw data, e.g., analog data. In some embodiments, the motion input 112 and/or non-motion input 114 are received as digitized raw data, e.g., digitally sampled analog data. In some embodiments, the motion input 112 and/or non-motion input 114 are received as processed data, e.g., packaged, formatted, noise-filtered, and/or compressed data. In some embodiments, the motion input 112 and non-motion input 114 are combined and provided to the system's engine module 106 as a raw data stream 117. The raw data stream can comprise segments of motion input 112 and non-motion input 114 with no particular formatting of the overall data stream.

In some embodiments, data preprocessing can occur prior to delivering motion and non-motion data to the engine module 106. As an example, motion sensor data can be converted into higher-level motion components external to the system 100. Referring to FIG. 3, motion sensors on the motion-capture device 310 can generate analog data which can be preprocessed by an on-board microcontroller into higher level motion components, e.g., position, velocity, acceleration, pitch, roll, yaw, etc., at a level below the system's engine module 106. All of these can be qualified as “motion” data, and the generated data may include a unique header or ID indicating that the data is of a particular type, e.g., velocity. If preprocessed data is provided to the system 100, then sensor input profiles are provided within the system's sensor input profiler 120 for association with each type of preprocessed data. The sensor input profiles may include information about the units (in, cm, m, in/sec, cm/sec, etc.) attributable to the data types.

In various embodiments, data segments within the input data 117 have unique headers or configuration ID's indicating the type of data within the segment. For example, one segment can have a configuration ID indicating that the data segment originated from a particular motion sensing device. Another data segment can have a configuration ID indicating that the data segment originated from a joystick. Another data segment can have a configuration ID indicating that the data segment originated from a photodetector.

### IV-B-1. Raw Data Stream

As an example of a raw data stream 117 received by the system's engine module 106, an illustrative embodiment is described in reference to FIG. 3A, FIG. 3D, FIG. 3E and FIG. 3G. For purposes of this illustrative embodiment, the motion 320 of a motion-capture device 310, as depicted in FIG. 3A, comprises an upward half-circle to the right 320. In this embodiment, the motion-capture device 310 can comprise a remote controller incorporating motion-capture devices as described in U.S. provisional applications No. 60/020,574 and No. 61/084,381. The motion-capture device 310 can be moved substantially in accordance with motion 320 to generate motion data representative of the motion 320. For purposes of the illustrative embodiment, the motion data representative of the motion 320 is represented as [ID₁, d1₁, d1₂, d1₃, . . . , d1_{N1}] where ID₁ represents a configuration ID and d1 designates a particular data sequence and NJ is an integer. The motion data representative of the motion 335 can be represented as [ID₁, d2₁, d2₂, d2₃, . . . , d2_{N2}]. The motion data representative of the motion 340 can be represented as [ID₁, d3₁, d3₂, d3₃, . . . , d3_{N3}]. The motion data representative of the motion 350 can be represented as [ID₁, d4₁, d4₂, d4₃, . . . , d4_{N4}]. In addition to these motion data, non-motion data may be produced before, after or during motion of the motion-capture device 310. For purposes of this illustrative embodiment, only one type of non-motion data will be considered, e.g. a button press having two data states—on, off. The button press data can be represented as [ID₂, b₁1] and [ID₂, b₁0]. It will be appreciated that many more types of non-motion data can be generated during operation of the system, e.g. keypad data, data output from analog joysticks, data from digital pads, video and/or optically produced data. It will be appreciated that the combination of motion data and non-motion data provided to the system 100 can be unlimited.

The motion and non-motion data can be executed at separate times or at substantially the same time, and yet various types of motion and non-motion data are distinguishable by the system 100. For example, a button press can occur during a motion, and the button press and particular motion are distinguished by the system's engine module 106. The motion data can occur sequentially with periods of delay between each motion, or may occur sequentially without any substantial delay between the motions. As an example, in one operational mode motion 320 can be completed and followed at a later time by motion 335. Each of these two motions can result in distinct outputs from the engine module 106. In another operational mode, motion 320 can be followed substantially immediately by motion 335, and this sequence of motions is interpreted by the system's engine module 106 to be motion 340. In various embodiments, similar movements, e.g., motion 320 and motion 350, are distinguishable by the system' engine module 106 based upon characteristics of the motion and generated data.

Continuing with the Example, in a video gaming environment each motion and non-motion input can correspond to one or more desired actions of an avatar. For example, motion 320 can enact rolling to the right, motion 335 can enact ducking movement to the left, motion 340 can enact forming a shield around the avatar, and 350 can enact jumping to the right. A button press “on” may enact firing of a laser beam, and a button press “off” may enact terminating a laser beam. Additional action events can be enacted by the same motion and non-motion inputs, wherein a particular action event is selected by the system's engine module depending upon the context or environment within which the motion or non-motion data is produced.

For the purposes of the illustrative embodiment described above and following the notation developed therein, an example of a raw data stream can be represented as follows: [ID₁, d4₁, d4₂, d4₃, . . . , d4_{N4}] [ID₂, b₁1] [ID₂, b₁0] [ID₁, d1₁, d1₂, d1₃, . . . , d1_{N1}] [ID₁, d2₁, d2₂, d2₃] [ID₂, b₁1] [ID₁, d2₄ . . . , d2_{N2}] [ID₂, b₁0] [ID₁, d3₁, d3₂, d3₃, . . . , d3_{N3}].

This sequence of data in the raw data stream can then correspond to the following desired actions: jump to the right (motion 350), laser on (button press), laser off (button release), roll to the right (motion 320), duck to the left (motion 335) and fire laser (button press), laser off (button release), form a shield (motion 340).

### IV-B-2. Profiling of Raw Data Stream

When received by the engine module 106, a raw data stream 117 is provided to a data profile processor 172. In various embodiments, the data profile processor 172 interacts with the sensor profile unit 160 as it receives the raw data stream 117. The sensor profile unit 160 can contain information provided from the sensor input profiler 120, the data description language 130, the AI algorithms 140, and statistics algorithms 150. Additionally, the profile unit 160 can be in communication with an application 190 adapted for remote control and receive information about an operational state of the application 190. The data profile processor 172 can comprise computer code executed on a processor, the code utilizing information from the sensor profile unit 160 to identify each data segment received in the data stream 117 and associate a correct sensor input profile 200 with the data segment. The data profile processor 172 can then create a data profile 173 comprising metadata from the identified segment. Continuing with the Example, a data segment [ID₁, d4₁, d4₂, d4₃, . . . , d4_{N4}] can be identified by the data profile processor 172 as originating from a particular motion-capture sensor having configuration identification ID₁. The data profile processor 172 can then attach a corresponding sensor input profile 200, designated as sip₁, to the data segment. The resulting data profile can be represented as [sip₁, d4₁, d4₂, d4₃, . . . , d4_{N4}] which is included in a data profile stream 173 provided to the interpreter 174. After processing by the data profile processor 172, the exemplified raw data stream can be output as the following profile data stream:

[sip₁, d4₁, d4₂, d4₃, . . . , d4_{N4}] [sip₂, b₁1] [sip₂, b₁0] [sip₁, d1₁, d1₂, d1₃, . . . , d1_{N1}]

[sip₁, d2₁, d2₂, d2₃] [sip₂, b₁1] [sip₁, d2₄ . . . , d2_{N2}] [sip₂, b₁0] [sip₁, d3₁, d3₂, d3₃, . . . , d3_{N3}]

In some embodiments, the configuration ID is retained in the data profile, e.g., as in the following exemplified profile data stream:

[sip₁, ID₁, d4₁, d4₂, d4₃, . . . , d4_{N4}] [sip₂, ID₂, b₁1] [sip₂, ID₂, b₁0]
[sip₁, ID₁, d1₁, d1₂, d1₃, . . . , d1_{N1}] [sip₁, ID₁, d2₁, d2₂, d2₃] [sip₂, ID₂,
b₁1] [sip₁, ID₁, d2₄ . . . , d2_{N2}] [sip₂, ID₂, b₁0] [sip₁,
ID₁, d3₁, d3₂, d3₃, . . . , d3_{N3}]

Retaining the configuration ID within the data profile can facilitate interpretation of the data and matching of symbols.

In some embodiments, the engine module 106 can process corrupted or unrecognizable data. In certain embodiments, data received lacking a configuration ID can be discarded by the data profile processor 172. In certain embodiments, data received lacking a configuration ID can be associated with a default sensor input profile, e.g., a sensor input profile indicated that the data source is unknown. In some embodiments, unknown data can be recovered at the interpretation phase by assigning sequentially valid configuration ID's to create test data sets and determining whether valid symbols exists for the test data sets.

### IV-B-3. Interpretation of Profiled Data

In various embodiments, the interpreter 174 receives a stream of data profiles 173 from the data profile processor 172. The interpreter 174 interacts with the sensor profile unit 160 as it receives the stream of data profiles. The interpreter 174 can comprise computer code executed on a processor, the code utilizing information from the sensor profile unit 160 to convert one or more data profiles received in a data profile stream 173 into one or more non-contextual tokens which are output in a non-context token stream 175. The conversion from data profiles to tokens can be a two step process wherein the received data profiles are first converted to valid symbols, forming a symbol stream, and the symbols are processed and converted to tokens.

In various aspects, the interpreter 174 determines best matches between received data profiles and symbols provided from the symbols module 132. If best matches are found, e.g., a symbol exists for the data profile, the data profile is validated and the interpreter produces one or more symbols to include in a symbol data stream. If best matches are not found for a data profile, the data profile or portion thereof may be discarded. An advantageous feature of creating metadata at the data profile processor 172 is that large data segments can be handled quickly and efficiently. For example, a sensor input profile within a data profile can be interrogated quickly to determine information about a large data segment and where best to search for one or more symbols that can validate the data. The sensor input profile information within a data profile can also provide information about how to process the data.

Continuing with the illustrative embodiment, the interpreter can receive a data profile represented as [sip₁, d4₁, d4₂, d4₃, . . . , d4_{N4}]. The interpreter can interrogate the sensor input profile sip₁ of the metadata to quickly determine where to search within a symbols database 132 for symbols which will match and validate data within the data profile. For each portion of the data profile which is validated by a symbol, the symbol is provided to a symbol data stream. For example, the particular data profile [sip₁, d4₁, d4₂, d4₃, . . . , d4_{N4}] may return a symbol data stream comprising [sip₁, c₁, c₂, c₃, . . . , c₆₄] where cₙ is representative of a 1/128^{th} arc segment of a circle.

The interpreter 174 can further determine best matches between sets, subsets or sequences of symbols in the generated symbol stream and tokens provided from the dictionary 134. If best matches are found, the interpreter produces one or more non-contextual tokens or commands for its output non-contextual token stream 175 or non-contextual command stream 184. If a best match is not found for a set, subset or sequence of symbols, one or more symbols in the symbol data stream can be discarded. Continuing with the illustrative embodiment, the symbol data stream [sip₁, c₁, c₂, C₃, . . . , c₆₄] can be processed further by the interpreter 174 which, aided by information provided by the sensor input profile sip₁, can quickly determine where to look for tokens which validate the generated symbols. When one or more tokens are found to validate the generated symbols, the tokens can be provided as output by the interpreter 174. Following with the illustrative embodiment, the interpreter 174 can generate a token sequence [qcq₁, qcq₂] from the symbol data stream where qcqₙ is representative of a quarter circle in the n^{th} quadrant. The generated tokens can be provided to a non-contextual token stream 175 or non-contextual command stream 184 output by the interpreter 174.

In certain aspects, non-motion data may punctuate motion data. For example, in the illustrative embodiment, an input data segment [ID₁, d2₁, d2₂, d2₃] [ID₂, b₁1] [ID₁, d2₄ . . . , d2_{N2}] of the raw data stream indicates motion 335 punctuated by non-motion data, a button press to an “on” state. After profiling, the associated data profiles can comprise [sip₁, d2₁, d2₂, d2₃] [sip₂, b₁1] [sip₁, d2₄ . . . , d2_{N2}]. In various embodiments, the interpreter 174 utilizes information provided by the sensor input profiles sipₙ to process similar data. For example, the interpreter 174 can concatenate the data profiles according to similar sensor input profile types prior to validating the received data with symbols or tokens. In certain embodiments, concatenation is only allowed for data received within a selected time limit, e.g., within about 10 milliseconds (s), within about 20 ms, within about 40 ms, within about 80 ms, within about 160 ms, within about 320 ms, within about 640 ms, and in some embodiments within about 1.5 seconds. As an example, a selected time limit may be about 80 ms. For this time limit, a data profile received 60 ms after a data profile is concatenated with the prior received data profile of similar sensor input profile type. A data profile received 100 milliseconds after a data profile having similar sensor input profile type would not be concatenated with the prior data profile having a similar sensor input profile type. In accordance with these steps, the data profile [sip₁, d2₁, d2₂, d2₃] [sip₂, b₁1] [sip₁, d2₄ . . . , d2_{N2}] in the illustrative example can be processed by the interpreter 174 to yield either [sip₁, d2₁, d2₂, d2₃, d2₄ . . . , d2_{N2}] [sip₂, b₁1] or [sip₂, b₁1] [sip₁, d2₁, d2₂, d2₃, d2₄ . . . , d2_{N2}] corresponding to motion 335 and a button press, i.e. the intended actions carried out to produce a desired result.

In various embodiments, interpreter 174 inserts stop or space tokens into the token stream based upon timing of the received data. As an example, raw data received at different times can be separated in the data stream by one or more stop or space tokens. The stop or space tokens can be representative of an amount of time delay. In some embodiments, the data profile processor 172 inserts the stop or space characters into the data profile stream 173, and the interpreter 174 associates stop or space tokens with the stop or space characters.

In certain embodiments, the interpreter 174 processes the data profiles using artificial intelligence (AI) and/or statistical algorithms. As an example, the motion sequence 320 depicted in FIG. 3A is substantially representative of a half circle, but is not precisely a have circle. The motion path can be longer or shorter than a true path for a half circle, and the path itself can deviate from a path for a true half circle. In various embodiments, the interpreter 174 utilizes AI and/or statistical algorithms at the symbol validation phase of data processing to accommodate imprecision and approximation of data segments received in the data profile stream 173.

Returning to the Example, after processing by the interpreter, the exemplified data profile stream can be output as the following non-contextual token stream:

[lt₃, lt₁, s, lz₁, s, lz₀, s, s, qcq₄, qcq₁, s, qcq₂, qcq₃, lz₁, s, lz₀, s, s, s, qcq₄, qcq₁, qcq₂, qcq₃]

In this example of a token stream, ltₙ represents a token representative of motion of an n^{th} leg of a triangle, qcqₙ represents a token representative of a quarter circle motion in an n^{th} quadrant, lzₙ represents a token representative of a laser status, and s represents a token representative of a time delay.

### IV-B-4. Parsing of Interpreted Data

In various embodiments, the parser 176 receives a non-contextual token stream 175 from the interpreter 174. The parser 176 also interacts with the sensor profile unit 160 as it receives the stream of non-contextual tokens. The parser 176 can comprise computer code executed on a processor, the code utilizing information from the sensor profile unit 160 and/or the data description language 130 to convert one or more tokens received in the non-contextual token stream 175 into one or more contextual tokens. The contextual tokens can be provided as output to an application 190 in a context-based command stream 182.

In various aspects, the parser 176 utilizes information derived from the grammar 136 module of the data description language 130 in determining whether a valid contextual token exists for a non-contextual token or sequence of non-contextual tokens. If a match is determined, the parser can replace the one or more non-contextual tokens with a context token. Returning to the exemplified non-contextual token stream output by the interpreter 174, the parser can process the received non-contextual tokens to obtain the following mixed token stream comprising both non-contextual tokens and contextual tokens:

[JR, S₁, lz₁, S₁, lz₀, S₂, RR, S₁, DL, lz₁, S₁, lz₀, S₃, SF]

In this example of a mixed token stream produced by the parser 176, JR represents a contextual token representative of a command for an avatar to jump to the right, Sₙ represents a contextual token representative of a command to wait or delay for n time intervals, RR represents a contextual token representative of a command for an avatar to roll to the right, DL represents a contextual token representative of a command for an avatar to duck to the left, and SF represents a contextual token representative of a command to form a shield around an avatar.

In certain embodiments, after the parser 176 processes received non-contextual token stream, output commands recognizable by the external application 190 are associated with the processed non-contextual tokens. In some embodiments, recognizable output commands are associated with non-contextual tokens which are not converted to contextual tokens during processing by the parser 176. Association of contextual and non-contextual tokens can be carried out by the sensor profile unit 160 using look-up tables. In various embodiments, the parser 176 provides a command data stream 182 to an external application 190 adapted for external control.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

The section headings used herein are for organizational purposes only and are not to be construed as limiting the subject matter described in any way.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A method comprising:
receiving, by a data profile processor, input data, the input data comprising motion data and non-motion data, the motion data provided by one or more motion-capture devices and representative of aspects of motion of the one or more motion-capture devices;
generating, by the data profile processor, a stream of data profiles, a data profile comprising metadata associated with a segment of the received input data; and
processing, by an interpreter, the data profiles to generate non-contextual tokens, the non-contextual tokens representative of the motion data and non-motion data.

2. The method of claim 1, wherein a motion-capture device is a video game controller.

3. The method of claim 1, wherein the data profile processor comprises software and/or firmware executing on a processor.

4. The method of claim 1, wherein the interpreter comprises software and/or firmware executing on a processor.

5. The method of claim 1, wherein the generating is carried out on plural computational threads, each thread processing data corresponding to one motion-capture device.

6. The method of claim 1, wherein the processing is carried out on plural computational threads, each thread processing data corresponding to one motion-capture device.

7. The method of claim 1, wherein the stream of input data is unformatted.

8. The method of claim 1, wherein a segment of data within the stream of input data includes a header or configuration ID indicating the type of data within the segment.

9. The method of claim 1, wherein the aspects of motion include an element selected from the following group: current position, current orientation, rotational velocity, rotational acceleration, velocity, acceleration, and any combination thereof.

10. The method of claim 1, wherein the step of generating comprises associating, by the data profile processor, a sensor input profile with a segment of the received input data.

11. The method of claim 10, wherein the associating is based upon a header or configuration ID included with the data segment.

12. The method of claim 10, wherein the sensor input profile comprises information about the device which generated the data segment and/or information about the data.

13. The method of claim 10, wherein the sensor input profile is provided to the data profile processor from a sensor input profile database, and wherein the sensor input profile database was created at development time.

14. The method of claim 10, wherein the sensor input profile is provided to the data profile processor from a sensor profile unit, the sensor profile unit comprising software and/or firmware executing on a processor and in communication with memory.

15. The method of claim 1, wherein the step of processing comprises:
receiving, by the interpreter, the stream of data profiles;
associating, by the interpreter, at least one symbol with at least a portion of a data sequence included in a data profile; and
providing, by the interpreter, for further processing one or more symbols in a symbol data stream.

16. The method of claim 15, wherein the associating, by the interpreter, employs artificial intelligence and/or statistical algorithms.

17. The method of claim 15, wherein the at least one symbol is provided to the interpreter from a data description language database, and wherein the data description language database was created at development time.

18. The method of claim 15, wherein the at least one symbol is provided to the interpreter from a sensor profile unit, the sensor profile unit comprising software and/or firmware executing on a processor and in communication with memory.

19. The method of claim 15, wherein the at least one symbol was created using artificial intelligence and/or statistical algorithms.

20. The method of claim 15, further comprising:
associating, by the interpreter, at least one non-contextual token with one or more symbols in the symbol data stream; and
providing, by the interpreter, for further processing one or more non-contextual tokens in a non-contextual token stream.

21. The method of claim 20, wherein the at least one non-contextual token is provided to the interpreter from a data description language database created at development time.

22. The method of claim 20, wherein the at least one non-contextual token is provided to the interpreter from a sensor profile unit, the sensor profile unit comprising software and/or firmware executing on a processor and in communication with memory.

23. The method of claim 20, wherein the at least one non-contextual token was created using artificial intelligence and/or statistical algorithms.

24. The method of claim 20, further comprising:
associating, by the interpreter, a non-context-based command recognizable by an application adapted for external control with a non-contextual token; and
providing, by the interpreter, the non-context-based command to the application.

25. The method of claim 20, further comprising:
receiving, by a parser, the non-contextual token stream;
associating, by the parser, at least one contextual token with at least a portion of the non-contextual token stream;
associating, by the parser, a context-based command recognizable by an application adapted for external control with a contextual token; and
providing, by the parser, the context-based command to the application.

26. The method of claim 25, wherein the associating, by the parser, of a contextual token is based upon grammar rules and the grammar rules are provided to the parser from a data description language database created at development time.

27. The method of claim 25, wherein the associating, by the parser, of a contextual token is based upon grammar rules and the grammar rules are provided to the parser from a sensor profile unit, the sensor profile unit comprising software and/or firmware executing on a processor and in communication with memory.

28. A system comprising:
a data profile processor adapted to receive input data, the input data comprising motion data and non-motion data, the motion data provided by one or more motion-capture devices and representative of aspects of motion of each motion-capture device, wherein
the data profile processor is adapted to generate a stream of data profiles, a data profile comprising metadata associated with a segment of the received input data; and
an interpreter adapted to receive a stream of data profiles and to generate non-contextual tokens from the stream of data profiles, the non-contextual tokens representative of the motion data and non-motion data.

29. The system of claim 28 including a motion-capture device comprising a video game controller.

30. The system of claim 28, wherein the data profile processor comprises software and/or firmware executing on a processor.

31. The system of claim 28, wherein the interpreter comprises software and/or firmware executing on a processor.

32. The system of claim 28, wherein the data profile processor and/or interpreter includes plural computational threads, each thread processing data corresponding to one motion-capture device.

33. The system of claim 28, wherein the interpreter is further adapted to process the stream of non-contextual tokens and provide a stream of commands to an application adapted for external control, the commands associated with non-contextual tokens and recognizable by the application.

34. The system of claim 28 further comprising a sensor input profile database, wherein the data profile processor is in communication with the sensor input profile database and the data profile processor associates a sensor input profile with a segment of the received input data to produce a data profile.

35. The system of claim 34, wherein the associating is based upon a header or configuration ID included with the data segment.

36. The system of claim 34, wherein the sensor input profile comprises information about the device which generated the data segment and/or information about the data.

37. The system of claim 28 further comprising a parser, the parser adapted to receive a stream of non-contextual tokens from the interpreter, process the non-contextual tokens to form one or more contextual tokens, and provide a stream of commands to an application adapted for external control, the commands associated with non-contextual tokens and contextual tokens and recognizable by the application.

38. The system of claim 28 further comprising:
a sensor profile unit, the sensor profile unit comprising software and/or firmware executing on a processor and in communication with memory; wherein
the sensor profile unit is in communication with the data profile processor and the interpreter; and
the sensor profile unit is configured at development time.

39. The system of claim 38 further comprising a creation module, the creation module comprising:
a system developer kit, the system developer kit providing a user interface to alter elements within the creation module;
a sensor input profiler comprising a database of sensor input profiles, each sensor input profile containing information about a hardware device and/or data produced by the hardware device;
a data description language comprising a symbols database, a dictionary database, and a grammar database;
an AI algorithms database; and
a statistics algorithms database.

40. A system comprising:
an engine module, the engine module adapted to receive input data, the input data comprising motion data and non-motion data, the motion data provided by one or more motion-capture devices and representative of aspects of motion of the one or more motion-capture devices;
the engine module further adapted to process the motion and non-motion data to produce contextual and/or non-contextual tokens;
the engine module further adapted to associate commands with the contextual and/or non-contextual tokens, the commands recognizable by an application adapted for external control;
the engine module in communication with the application and further adapted to provide the commands to the application; and
the engine module comprising a sensor profile unit, the sensor profile unit configurable at development time and reconfigurable at run time.
